(19) United States
(12) Patent Application Publication
(10) Pub. No.: US 2021/0056390 A1
(43) Pub. Date: Feb. 25, 2021

(54) Method and Apparatus of Neural Networks with Grouping for Video Coding

(71) Applicant: MEDIATEK INC., Hsinchu City (TW)

(72) Inventors: Ching-Yeh CHEN, Hsinchu City (TW); Tzu-Der CHUANG, Hsinchu City (TW); Yu-Wen HUANG, Hsinchu City (TW); Jan KLOPP, Hsinchu City (TW)

(21) Appl. No.: 16/963,566

(22) PCT Filed: Jan. 22, 2019
(86) PCT No.: PCT/CN2019/072672

§ 371 Date: Jul. 21, 2020

Related U.S. Application Data
(60) Provisional application No. 62/622,226, filed on Jan. 26, 2018.
(60) Provisional application No. 62/622,224, filed on Jan. 26, 2018.

(51) Int. Cl. G06N 3/04; H04N 19/42

(52) U.S. Cl. CPC G06N 3/0454; H04N 19/439

(57) ABSTRACT

A method and apparatus of signal processing using a grouped neural network (NN) process are disclosed. A plurality of input signals for a current layer of NN process are grouped into multiple input groups comprising a first input group and a second input group. The neural network process for the current layer is partitioned into multiple NN processes comprising a first NN process and a second NN process. The first NN process and the second NN process are applied to the first input group and the second input group to generate a first output group and a second output group for the current layer of NN process respectively. In another method, the parameter set associated with a layer of NN process is coded using different code types.

### CROSS REFERENCE TO RELATED APPLICATIONS

The present invention claims priority to U.S. Provisional Patent Application Ser. No.

62/622,224, filed on Jan. 26, 2018 and U.S. Provisional Patent Application Ser. No. 62/622,226, filed on Jan. 26, 2018. The U.S. Provisional Patent Applications are hereby incorporated by reference in their entireties.

### FIELD OF THE INVENTION

The invention relates generally to Neural Networks. In particular, the present invention relates to reducing the complexity of the Neural Network (NN) processing by grouping the inputs to a given layer of the neural network into multiple input groups.

### BACKGROUND AND RELATED ART

Neural Network (NN), also referred as an ‘Artificial’ Neural Network (ANN), is an information-processing system that has certain performance characteristics in common with biological neural networks. A Neural Network system is made up of a number of simple and highly interconnected processing elements to process information by their dynamic state response to external inputs. The processing element can be considered as a neuron in the human brain, where each perceptron accepts multiple inputs and computes weighted sum of the inputs. In the field of neural network, the perceptron is considered as a mathematical model of a biological neuron. Furthermore, these interconnected processing elements are often organized in layers. For recognition applications, the external inputs may correspond to patterns are presented to the network, which communicates to one or more middle layers, also called ‘hidden layers’, where the actual processing is done via a system of weighted ‘connections’.

Artificial neural networks may use different architecture to specify what variables are involved in the network and their topological relationships. For example the variables involved in a neural network might be the weights of the connections between the neurons, along with activities of the neurons. Feed-forward network is a type of neural network topology, where nodes in each layer are fed to the next stage and there is connection among nodes in the same layer. Most ANNs contain some form of ‘learning rule’, which modifies the weights of the connections according to the input patterns that it is presented with. In a sense, ANNs learn by example as do their biological counterparts. Backward propagation neural network is a more advanced neural network that allows backwards error propagation of weight adjustments. Consequently, the backward propagation neural network is capable of improving performance by minimizing the errors being fed backwards to the neural network.

The NN can be a deep neural network (DNN), convolutional neural network (CNN), recurrent neural network (RNN), or other NN variations. Deep multi-layer neural networks or deep neural networks (DNN) correspond to neural networks having many levels of interconnected nodes allowing them to compactly represent highly non-linear and highly-varying functions. Nevertheless, the computational complexity for DNN grows rapidly along with the number of nodes associated with the large number of layers.

The CNN is a class of feed-forward artificial neural networks that is most commonly used for analysing visual imagery. A recurrent neural network (RNN) is a class of artificial neural network where connections between nodes form a directed graph along a sequence. Unlike feedforward neural networks, RNNs can use their internal state (memory) to process sequences of inputs. The RNN may have loops in them so as to allow information to persist. The RNN allows operating over sequences of vectors, such as sequences in the input, the output, or both.

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). The CTU is further partitioned into multiple coding units (CUs) to adapt to various local characteristics. HEVC supports multiple Intra prediction modes and for Intra coded CU, the selected Intra prediction mode is signalled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

FIG. 1A illustrates an exemplary adaptive Intra/Inter video encoder based on HEVC. The Intra/Inter Prediction unit 110 generates Inter prediction based on Motion Estimation (ME)/Motion Compensation (MC) when Inter mode is used. The Intra/Inter Prediction unit 110 generates Intra prediction when Intra mode is used. The Intra/Inter prediction data (i.e., the Intra/Inter prediction signal) is supplied to the subtractor 116 to form prediction errors, also called residues or residual, by subtracting the Intra/Inter prediction signal from the signal associated with the input picture. The process of generating the Intra/Inter prediction data is referred as the prediction process in this disclosure. The prediction error (i.e., residual) is then processed by Transform (T) followed by Quantization (Q) (T+Q, 120). The transformed and quantized residues are then coded by Entropy coding unit 122 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. Since a reconstructed picture may be used as a reference picture for Inter prediction, a reference picture or pictures have to be reconstructed at the encoder end as well. Consequently, the transformed and quantized residues are processed by Inverse Quantization (IQ) and Inverse Transformation (IT) (IQ+IT, 124) to recover the residues. The reconstructed residues are then added back to Intra/Inter prediction data at Reconstruction unit (REC) 128 to reconstruct video data. The process of adding the reconstructed residual to the Intra/Inter prediction signal is referred as the reconstruction process in this disclosure. The output picture from the reconstruction process is referred as the reconstructed picture. In order to reduce artefacts in the reconstructed picture, in-loop filters including Deblocking Filter (DF) 130 and Sample Adaptive Offset (SAO) 132 are used. The filtered reconstructed picture at the output of all filtering processes is referred as a decoded picture in this disclosure. The decoded pictures are stored in Frame Buffer 140 and used for prediction of other frames.

FIG. 1B illustrates an exemplary adaptive Intra/Inter video decoder based on HEVC. Since the encoder also contains a local decoder for reconstructing the video data, some decoder components are already used in the encoder except for the entropy decoder. At the decoder side, an Entropy Decoding unit 160 is used to recover coded symbols or syntaxes from the bitstream. The process of generating the reconstructed residual from the input bitstream is referred as a residual decoding process in this disclosure. The prediction process for generating the Intra/Inter prediction data is also applied at the decoder side, however, the Intra/Inter prediction unit 150 is different from that in the encoder side since the Inter prediction only needs to perform motion compensation using motion information derived from the bitstream. Furthermore, an Adder 114 is used to add the reconstructed residues to the Intra/Inter prediction data.

During the development of the HEVC standard, another in-loop filter, called Adaptive Loop Filter (ALF), is also disclosed, but not adopted into the main standard. The ALF can be used to further improve the video quality. For example, ALF 210 can be used after SAO 132 and the output from ALF 210 is stored in the Frame Buffer 140 as shown in FIG. 2A for the encoder side and FIG. 2B at the decoder side. For the decoder side, the output from the ALF 210 can also be used as decoder output for display or other processing. In this disclosure, de-blocking filter, SAO and ALF are all referred as a filtering process.

Among different image restoration or processing methods, neural network based method, such as deep neural network (DNN) or convolution neural network (CNN), is a promising method in the recent years. It has been applied to various image processing applications such as image de-noising, image super-resolution, etc., and it has been proved that DNN or CNN can achieve a better performance compared to traditional image processing methods. Therefore, in the following, we propose to utilize CNN as one image restoration method in one video coding system to improve the subjective quality or coding efficiency. It is desirable to utilize NN as an image restoration method in a video coding system to improve the subjective quality or coding efficiency for emerging new video coding standards such as High Efficiency Video Coding (HEVC). In addition, NN requires considerable computing complexity. It is also desirable to reduce the computational complexity of NN.

### BRIEF SUMMARY OF THE INVENTION

A method and apparatus of signal processing using a grouped neural network (NN) process, where the neural network process comprises one or more layers of NN process, are disclosed. According to this method, a plurality of input signals for a current layer of NN process are taken as multiple input groups comprising a first input group and a second input group for the current layer of NN process. The neural network process for the current layer of NN process is taken as multiple NN processes comprising a first NN process and a second NN process for the current layer of NN process. The first NN process and the second NN process are applied to the first input group and the second input group to generate a first output group and a second output group for the current layer of NN process respectively. An output group comprising the first output group and the second output group is provided as the output for the current layer of NN process.

An initial plurality of input signals provided to an initial layer of the neural network process may correspond to a target video signal in a path of video signal processing flow in a video encoder or video decoder. For example, the target video signal may correspond to a processed signal outputted from Reconstruction (REC), De-blocking Filter (DF), Sample Adaptive Offset (SAO) or Adaptive Loop Filter (ALF).

The method may further comprise taking the neural network process as multiple NN processes for a next layer of NN process including a first NN process and a second NN process for the next layer of NN process; and providing the first output group and the second output group for the current layer of NN process as a first input group and a second input group for the next layer of NN process to the first NN process and the second NN process for the next layer of NN process respectively without mixing the first output group and the second output group for the current layer of NN process. In another embodiment, the first output group and the second output group for the current layer of NN process can be mixed. In yet another embodiment, for at least one layer of NN process, a plurality of input signals for said at least one layer of NN process are processed by said at least one layer of NN process as a non-partitioned network without taking said at least one layer of NN process as multiple NN processes.

A method and apparatus for signalling a parameter set associated with neural network (NN) signal processing are disclosed. According to this method, the parameter set associated with a current layer of the neural network process are mapped using at least two code types by mapping a first portion of the parameter set associated with the current layer of the neural network process using a first code, and mapping a second portion of the parameter set associated with the current layer of the neural network process using a second code. The current layer of the neural network process is applied to input signals of the current layer of the neural network process using the parameter set associated with the current layer of the neural network process comprising the first portion of the parameter set associated with the current layer of the neural network process and the second portion of the parameter set associated with the current layer of the neural network process.

The system using this method may correspond to a video encoder or a video decoder. In this case, initial input signals provided to an initial layer of the neural network process may correspond to a target video signal in a path of video signal processing flow in the video encoder or the video decoder. When the initial input signals correspond to in-loop filtering signals, the parameter set is signalled in a sequence level, picture-level or slice level. When the initial input signals correspond to post-loop filtering signals, the parameter set is signalled as supplement enhancement information (SEI) message. The target video signal may correspond to a processed signal outputted from Reconstruction (REC), De-blocking Filter (DF), Sample Adaptive Offset (SAO) or Adaptive Loop Filter (ALF).

When the system corresponds to a video encoder, said mapping a parameter set associated with the current layer of the neural network process may correspond to encoding the parameter set associated with the current layer of the neural network process into coded data using the first code and the second code. When the system corresponds to a video decoder, said mapping a parameter set associated with the current layer of the neural network process may correspond to decoding the parameter set associated with the current layer of the neural network process from coded data using the first code and the second code.

The first portion of the parameter set associated with the current layer of the neural network process may correspond to weights associated with the current layer of the neural network process, and the second portion of the parameter set associated with the current layer of the neural network process corresponds to offsets associated with the current layer of the neural network process. In this case, the first code may correspond to a variable length code. Furthermore, the variable length code may correspond to a Huffman code or an n-th order exponent Golomb code (EGn) and n is an integer greater than or equal to 0. Different n can be used for different layers of the neural network process. The second code may correspond to a fixed length code. In another embodiment, the first code may correspond to a DPCM (differential pulse coded modulation) code, and wherein differences between the weights and a minimum of the weights are coded.

In yet another embodiment, different codes can be used in different layers. For example, the first code, the second code or both can be selected from a group comprising multiple codes. A target code selected from the group comprising multiple codes for the first code or the second code is indicated by a flag.

### BRIEF DESCRIPTION OF THE DRAWINGS

FIG. 1A illustrates an exemplary adaptive Intra/Inter video encoder based on the High Efficiency Video Coding (HEVC) standard.

FIG. 1B illustrates an exemplary adaptive Intra/Inter video decoder based on the High Efficiency Video Coding (HEVC) standard.

FIG. 2A illustrates an exemplary adaptive Intra/Inter video encoder similar to that in FIG. 1A with an additional ALF process.

FIG. 2B illustrates an exemplary adaptive Intra/Inter video decoder similar to that in FIG. 1B with an additional ALF process.

FIG. 3 illustrates an example of applying the neural network (NN) to the reconstructed signal, where the input of NNis reconstructed pixels from the reconstruction module (REC) and the output of NN is the NN-filtered reconstructed pixels.

FIG. 4 illustrates an example of conventional neural network process, where the outputs of all channels in the previous layer are used as the inputs of all filters in the current layer without grouping.

FIG. 5 illustrates an example of grouped neural network process according to an embodiment of the present invention, where the outputs of the previous layer before L1 are partitioned into two groups and the current layer of neural network process is also partitioned into two group. In this embodiment, the outputs of L1 Group A and L1 Group B are used as the inputs of L2 Group A and L2 Group B respectively without mixing.

FIG. 6 illustrates an example of grouped neural network process according to another embodiment of the present invention, where the outputs of the previous layer before L1 are partitioned into two groups and the current layer of neural network process is also partitioned into two group. In this embodiment, the outputs of L1 Group A and L1 Group B can be mixed and the mixed outputs can be used as the inputs of L2 Group A and L2 Group B.

FIG. 7 illustrates an exemplary flowchart of grouped neural network (NN) process for a system according to one embodiment of the present invention.

FIG. 8 illustrates an exemplary flowchart of neural network (NN) process in a system with different code types for the parameter set associated with NN process according to another embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

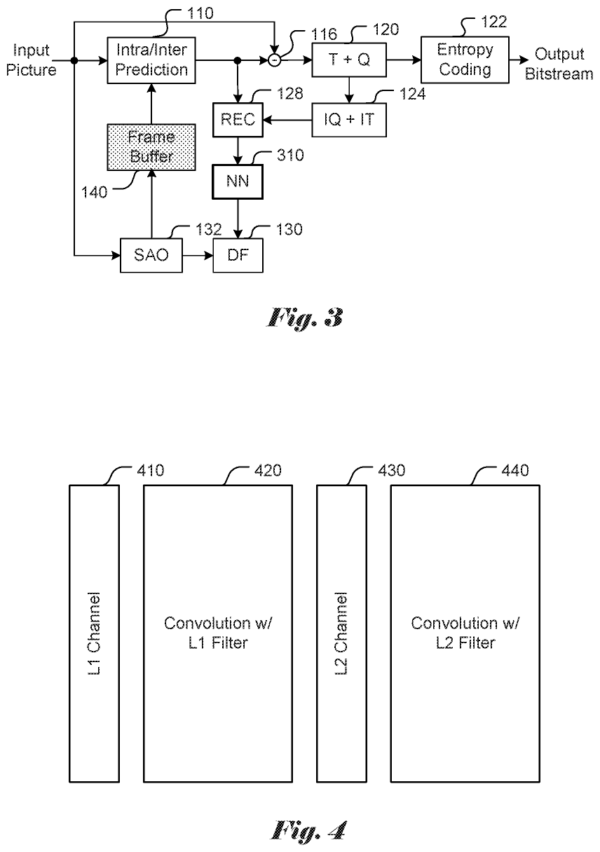

When the NN is applied to a video coding system, the NN may be applied to various signals along the signal processing path. FIG. 3 illustrates an example of applying NN 310 to the reconstructed signal. In FIG. 3, the input of NN310 is reconstructed pixels from REC 128. The output of NN is the NN-filtered reconstructed pixels, which can be further processed by de-blocking filter (i.e., DF 130). FIG. 3 is an example of applying the NN 310 in a video encoder; however, the NN 310 can be applied in a corresponding video decoder in the similar way. CNN can be replaced by other NN variations, for example, DNN (deep fully-connected feed-forward neural network), RNN (recurrent neural network), or GAN (generative adversarial network).

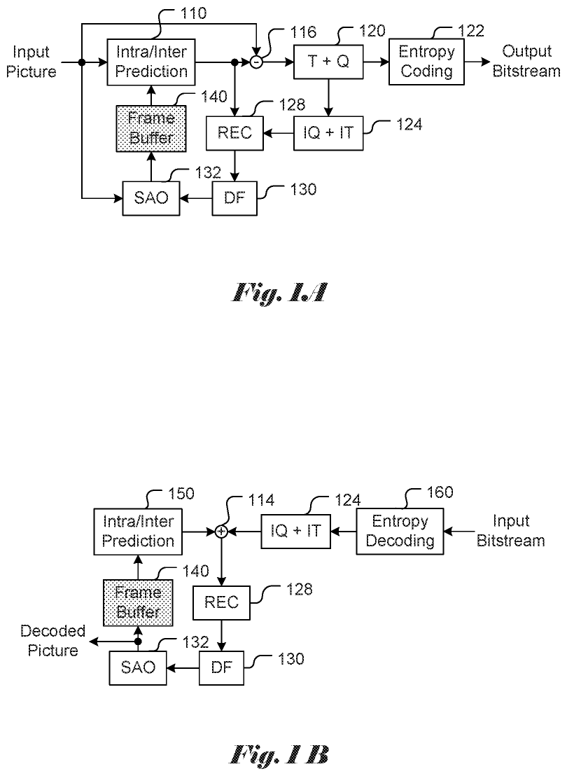

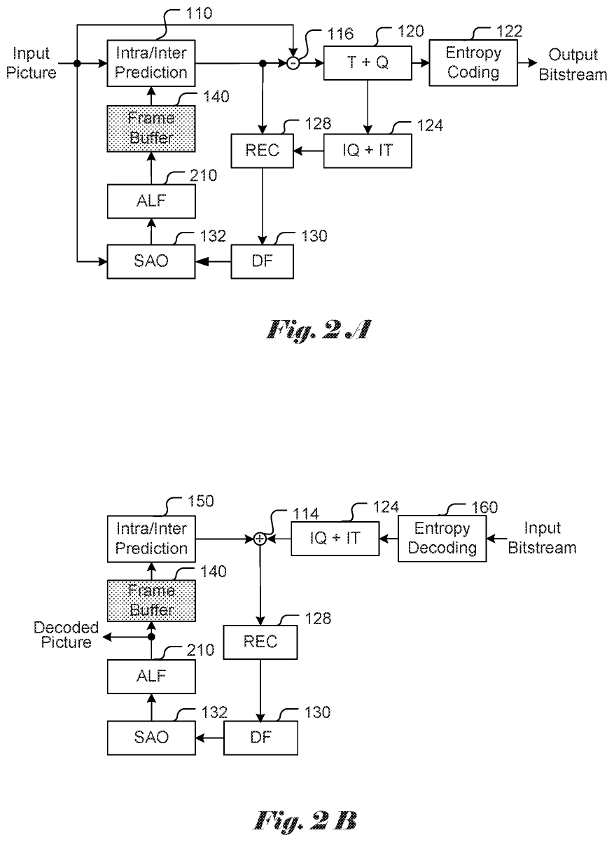

In the present invention, a method to utilize CNN as one image restoration method in a video coding system is disclosed. For example, the CNN can be applied to the ALF output picture in a video encoder and decoder as shown in FIGS. 2A and 2B to generate the final decoded picture. Alternatively, the CNN can be directly applied after SAO, DF or REC, with or without other restoration methods in a video coding system as shown in FIGS. 1A-Band FIGS. 2A-B. In another embodiment, CNN can be used to restore the quantization error directly or only improve the predictor quality. In the former, the CNN is applied after inverse quantization and transform to restore the reconstructed residual. In the latter, the CNN is applied on the predictors generated by the Inter or Intra prediction. In another embodiment, CNN is applied to the ALF output picture as a post-loop filtering.

In order to reducing the computational complexity of CNN, which may be useful especially in video coding systems, grouping technology is disclosed in the present invention. Traditionally, the network design of CNN is similar to fully connected network. The outputs of all channels in the previous layer are used as the inputs of all filters in the current layer, as shown in FIG. 4. In FIG. 4, the inputs of L1 410 and inputs of L2 430 are equal to the outputs of the previous layer before L1 420 and L2 440, respectively. Therefore, if the numbers of filters in the previous layer before L1 420 and L2 440 are equal to M and N respectively, then the numbers of input channels in L1 and L2 are M and N for each filter in L1 and L2 respectively. If the number of outputs in a previous layer (i.e., the number of inputs to a current layer) is M, the number of outputs in a current layer is N, the filter tap lengths are h and w in the horizontal and vertical directions respectively, the computational complexity for the current layer is proportional to h×w×M×N.

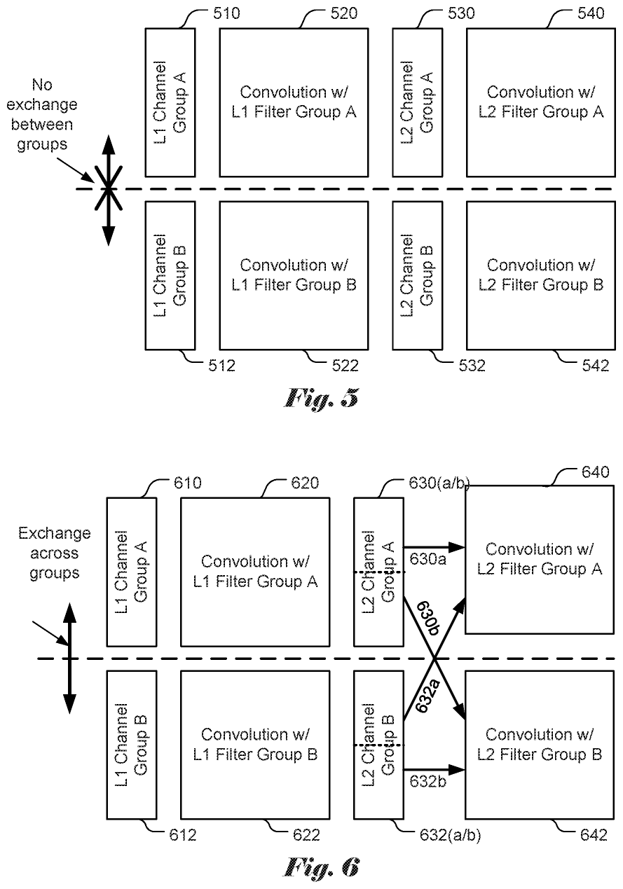

In order to reduce the complexity, a grouping technology is introduced in the network design of CNN. An example of the network design for CNN with grouping according to one embodiment of the present invention is shown in FIG. 5. In this example, the outputs of the previous layer before L1 are partitioned into or taken as two groups, L1 Channel Group A 510 and L1 Channel Group B 512. The convolution process is separated into or taken as two independent processes, i.e., Convolution with L1 Filter for Group A 520 and Convolution with L1 Filter for Group B 522. The next layer (i.e., L2) is also partitioned into or taken as two corresponding groups (530/532 and 540/542). However, in this design, there is no exchange between the two groups. This may cause the performance loss. In an example, the M inputs are divided into two groups consisting of (M/2) and (M/2) input and the N outputs are also divided into two groups consisting of (N/2) and (N/2). In this case, the computational complexity for the current layer is proportional to 1/2×(h×w×M×N).

In order to reduce the performance loss, another network design of the present invention is disclosed, where the processing of the CNN groups can be mixed as shown in FIG. 6. The outputs of the previous layer before L1 are partitioned into or taken as two groups, L1 Channel Group A 610 and L1 Channel Group B 612. The convolution process is separated into or taken as two independent processes, i.e., Convolution with L1 Filter for Group A 620 and Convolution with L1 Filter for Group B 622. The next layer (i.e., L2) is also partitioned into or taken as two corresponding groups (630/632 and 640/642),In this example, the outputs of L1 Group A and L1 Group B can be mixed and the mixed outputs can be used as the inputs of L2 Group A and L2 Group B, as shown in FIG. 6.

In an example, the M inputs are divided into two groups consisting of (M/2) and (M/2) input and the N outputs are also divided into two groups consisting of (N/2) and (N/2). The mixing can be achieved by, for example, taking part of the (N/2) outputs of L1 Group A 620a and part of the (N/2) outputs of L1 Group B 622 to form the (N/2) inputs of L2 Group A (i.e., the combination of 630a and 632a) and taking the remained part of the (N/2) outputs of L1 Group A and the remained part of the (N/2) outputs of L1 Group B to form the (N/2) inputs of L2 Group B(i.e., the combination of 630b and 632b). Accordingly, at least a portion of outputs of L1 Group A is crossed over into the L2 Group B (as shown in the direction 630b). Also, at least a portion of outputs of L1 Group B is crossed over into the inputs of L2 Group A (as shown in the direction 632a). In this case, the computational complexity for the current layer is proportional to 1/2×(h×w×M×N), which is the same as the case without mixing outputs of L1 Group A and L1 Group B. However, since there are some interactions between Group A and Group B, the performance loss can be reduced.

The grouping method or grouping with mixing method as disclosed above can be combined with the traditional design. For example, the grouping technology can be applied to the even layers and the traditional design (i.e., without grouping) can be applied to the odd layers. In another example, the grouping with mixing technology can be applied to those layers with the layer index modular by 3 equal to 1 and 2 and the traditional design can be applied to those layers with the layer index modular by 3 equal to 0.

When CNN is applied to video coding, the parameter set of CNN can be signalled to the decoder so that the decoder can apply the corresponding CNN to achieve a better performance. As is known in the field, the parameter set may comprise the weights and offsets for the connected network and the filter information. If the CNN is used as in-loop filtering, then the parameter set can be signalled at the sequence level, picture-level or slice level. If CNN is used as post-loop filtering, the parameter set can be signalled as supplement enhancement information (SEI) message. The sequence level, picture-level or slice level mentioned above correspond to difference video data structure.

The parameters in the CNN parameter set can be classified into two groups, such as weights and offsets. For different groups, different coding methods can be used to code the values. In one embodiment, the variable-length code (VLC) can be applied to the weights and fixed-length code (FLC) can be used to code the offsets. In another embodiment, the variable-length code table and the number of bits in fixed-length code can be changed for different layers. For example, for the first layer, the number of bits for the fixed-length code can be 8 bits; and in the following layers, the number of bits for fixed-length code is only 6 bits. In another example, for the first layer, the EG-0 (i.e., zero-th order Exp-Golomb) code can be used as the variable-length code and the EG-5 (i.e., fifth order Exp-Golomb) code can be used as the variable-length code for other layers. While specific 0-th order and 5-th order Exp-Golomb codes are mentioned as an example, any n-th order Exp-Golomb may be used as well, where n is an integer greater than or equal to 0.

In another embodiment, besides the variable-length code and fixed-length code, DPCM(differential pulse coded modulation)can be used to further reduce the coded information. In this method, the minimum value and maximum value among to-be-coded coefficients are determined first. Based on the difference between the minimum value and maximum value, the number of bits used to code the differences between to-be-coded coefficients and the minimum is determined. The minimum value and the number of bits used to code the differences are signalled first followed by the difference between to-be-coded coefficient and the minimum for each to-be-coded coefficient. For example, the to-be-coded coefficients are {20, 21, 18, 19, 20, 21}. When fixed-length code is used, these parameters will require 5-bit fixed-length code for each coefficient. When DPCM is used, the minimum value (18) and maximum value (21) among these 6 coefficients are determined first. The number of bits required to encode the difference between the minimum value (18) and the maximum value (21) is only 2 since the range of differences is between 0 and 3. Therefore, the minimum value (18) can be signalled by using 5-bit fixed-length code. The number of bits required to encode the difference between the minimum value (18) and the maximum value (21) can be signalled by using 3 bits fixed-length code. The differences between to-be-coded coefficients and the minimum, {2, 3, 0, 1, 2, 3} can be signalled using 2 bits. Therefore, the total bits are reduced from 30 bits=6 (i.e., the number of coefficients to be coded)×5 bits to 20 bits=(5 bits+3 bits+6×2 bits). The fixed-length code can be changed to truncated binary code, variable-length code, Huffman code, etc.

Different coding methods can be selected and used together. For example, DPCM and fixed-length code can be supported at the same time, and one flag is coded to indicate which method is used in the following coded bits.

CNN can be applied in various image applications, such as image classification, face detection, object detection, etc. The above methods can be applied when CNN parameters compression is required to reduce storage requirement. In this case, these compressed CNN parameters will be stored in some memory or devices, such as solid-state disk (SSD), hard-drive disk (HDD), memory stick, etc. These compressed parameters will be decoded and fed into CNN network to perform CNN process only when executing CNN process.

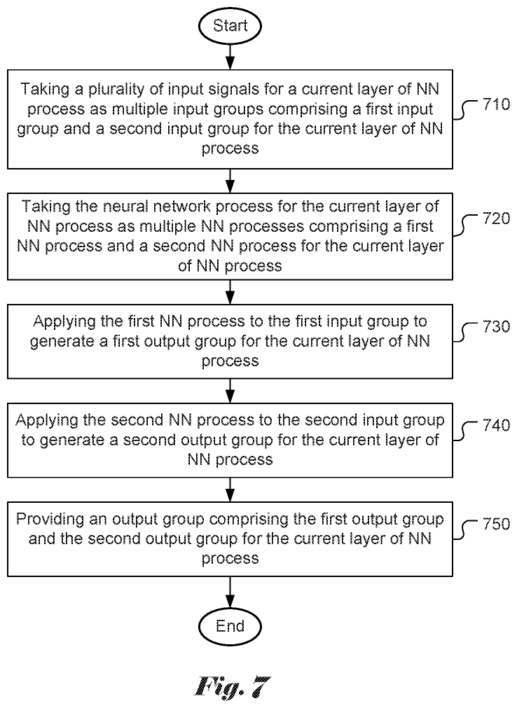

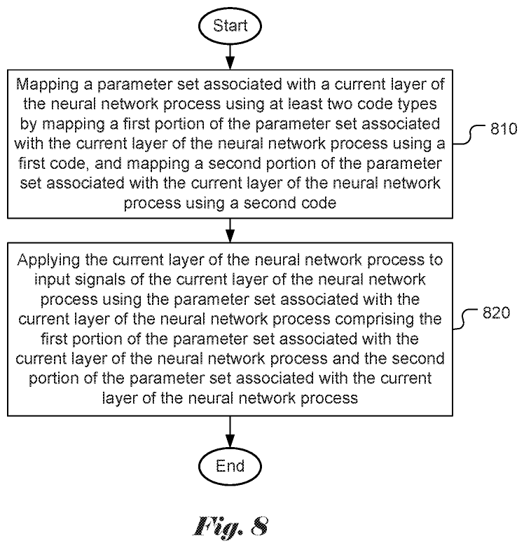

FIG. 7 illustrates an exemplary flowchart of grouped neural network (NN) process for a system according to one embodiment of the present invention. The steps shown in the flowchart may be implemented as program codes executable on one or more processors (e.g., one or more CPUs), an encoder side, decoder side, or any other hardware or software component being able to execute the program codes. The steps shown in the flowchart may also be implemented as hardware such as one or more electronic devices or processors arranged to perform the steps in the flowchart. The method takes a plurality of input signals for a current layer of NN process as multiple input groups comprising a first input group and a second input group for the current layer of NN process in step 710. The neural network process for the current layer of NN process is taken as multiple NN processes comprising a first NN process and a second NN process for the current layer of NN process in step 720. The first NN process is applied to the first input group to generate a first output group for the current layer of NN process in step 730. The second NN process is applied to the second input group to generate a second output group for the current layer of NN process in step 740. An output group comprising the first output group and the second output group for the current layer of NN process is provided as current outputs for the current layer of NN process in step 750.

FIG. 8 illustrates an exemplary flowchart of neural network (NN) process in a system with different code types for the parameter set associated with NN process according to another embodiment of the present invention. According to this method, a parameter set associated with a current layer of the neural network process is mapped using at least two code types by mapping a first portion of the parameter set associated with the current layer of the neural network process using a first code, and mapping a second portion of the parameter set associated with the current layer of the neural network process using a second code in step 810. The current layer of the neural network process is applied to input signals of the current layer of the neural network process using the parameter set associated with the current layer of the neural network process comprising the first portion of the parameter set associated with the current layer of the neural network process and the second portion of the parameter set associated with the current layer of the neural network process in step 820.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of signal processing using a neural network (NN) process, wherein the neural network process comprises one or more layers of NN process, the method comprising:
taking a plurality of input signals for a current layer of NN process as multiple input groups comprising a first input group and a second input group for the current layer of NN process;
taking the neural network process for the current layer of NN process as multiple NN processes comprising a first NN process and a second NN process for the current layer of NN process;
applying the first NN process to the first input group to generate a first output group for the current layer of NN process;
applying the second NN process to the second input group to generate a second output group for the current layer of NN process; and
providing an output group comprising the first output group and the second output group for the current layer of NN process as current outputs for the current layer of NN process.

2. The method of claim 1, wherein an initial plurality of input signals provided to an initial layer of the neural network process corresponds to a target video signal in a path of video signal processing flow in a video encoder or video decoder.

3. The method of claim 2, wherein the target video signal corresponds to a processed signal outputted from Reconstruction (REC), De-blocking Filter (DF), Sample Adaptive Offset (SAO) or Adaptive Loop Filter (ALF).

4. (canceled)

5. The method of claim 1, further comprising taking the neural network process as multiple NN processes for a next layer of NN process including a first NN process and a second NN process for the next layer of NN process; and providing the first output group and the second output group for the current layer of NN process as a first input group and a second input group for the next layer of NN process to the first NN process and the second NN process for the next layer of NN process respectively; and wherein at least a portion of the first output group for the current layer of NN process is crossed over into the second input group for the next layer of NN process or at least a portion of the second output group for the current layer of NN process is crossed over into the first input group for the next layer of NN process.

6. (canceled)

7. An apparatus for neural network (NN) processing using one or more layers of NN process, the apparatus comprising one or more electronics or processors arranged to:
take a plurality of input signals for a current layer of NN process as multiple input groups comprising a first input group and a second input group for the current layer of NN process;
take the neural network process for the current layer of NN process as multiple NN processes comprising a first NN process and a second NN process for the current layer of NN process;
apply the first NN process to the first input group to generate a first output group for the current layer of NN process;
apply the second NN process to the second input group to generate a second output group for the current layer of NN process; and
provide an output group comprising the first output group and the second output group for the current layer of NN process as current outputs for the current layer of NN process.

8. A method of signal processing using a neural network (NN) process in a system, wherein the neural network process comprises one or more layers of NN process, the method comprising:
mapping a parameter set associated with a current layer of the neural network process using at least two code types by mapping a first portion of the parameter set associated with the current layer of the neural network process using a first code, and mapping a second portion of the parameter set associated with the current layer of the neural network process using a second code; and
applying the current layer of the neural network process to input signals of the current layer of the neural network process using the parameter set associated with the current layer of the neural network process comprising the first portion of the parameter set associated with the current layer of the neural network process and the second portion of the parameter set associated with the current layer of the neural network process.

9. (canceled)

10. The method of claim 9, wherein initial input signals provided to an initial layer of the neural network process corresponds to a target video signal in a path of video signal processing flow in the video encoder or the video decoder.

11. The method of claim 10, wherein when the initial input signals correspond to in-loop filtering signals, the parameter set is signalled in a sequence level, picture-level or slice level.

12. The method of claim 10, wherein when the initial input signals correspond to post-loop filtering signals, the parameter set is signalled as supplement enhancement information (SEI) message.

13. (canceled)

14. (canceled)

15. The method of claim 8, wherein when the system corresponds to a video decoder, said mapping a parameter set associated with the current layer of the neural network process corresponds to decoding the parameter set associated with the current layer of the neural network process from coded data using the first code and the second code.

16. The method of claim 8, wherein the first portion of the parameter set associated with the current layer of the neural network process corresponds to weights associated with the current layer of the neural network process, and the second portion of the parameter set associated with the current layer of the neural network process corresponds to offsets associated with the current layer of the neural network process.

17. The method of claim 16, wherein the first code corresponds to a variable length code.

18. (canceled)

19. (canceled)

20. The method of claim 16, wherein the second code corresponds to a fixed length code.

21. (canceled)

22. The method of claim 8, wherein the first code, the second code or both are selected from a group comprising multiple codes.

23. The method of claim 22, wherein a target code selected from the group comprising multiple codes for the first code or the second code is indicated by a flag.

24. (canceled)
